(19) United States
(12) Patent Application Publication
(10) Pub. No.: US 2026/0139384 A1
(43) Pub. Date: May 21, 2026

(54) SYSTEM FOR RENEWABLE HYDROGEN PRODUCTION AND STORAGE USING AN ATMOSPHERIC WATER GENERATOR

(71) Applicant: UNIVERSITY OF SHARJAH, SHARJAH (AE)

(72) Inventors: Chaouki GHENAI, Sharjah (AE); Fahad Faraz AHMAD, Sharjah (AE)

(21) Appl. No.: 18/955,335

(22) Filed: Nov. 21, 2024

(51) Int. Cl. C25B 1/04; C01B 3/00; C25B 15/08

(52) U.S. Cl. CPC C25B 1/04; C01B 3/0031; C25B 15/083

(57) ABSTRACT

The present disclosure discloses a system for renewable hydrogen generation and storage. The system comprises at least one solar photovoltaic (PV) panel; an atmospheric water generator configured to extract water from a humid atmosphere; a water electrolyzer configured receive the water extracted by the atmospheric water generator and configured to produce hydrogen and oxygen from the water using electrolysis; and a metal hydride storage tank for storing the hydrogen produced by the water electrolyzer. Waste heat generated by the atmospheric water generator is used for thermal management of the metal hydride storage tank. A method for producing and storing hydrogen is also provided.

### FIELD

The present disclosure relates to a system for renewable hydrogen production and storage. More specifically, but not exclusively, the present disclosure relates to a system for renewable hydrogen generation that generates electricity using solar photovoltaic (PV) panels, an atmospheric water generator, and storage that stores hydrogen in a metal hydride storage tank.

### BACKGROUND

Background description includes information that will be useful in understanding the present invention. It is not an admission that any of the information provided herein is prior art or relevant to the presently claimed invention, or that any publication specifically or implicitly referenced is prior art.

Renewable energy is one of the solutions considered to address the global energy and environmental issues that are becoming more pertinent as time progresses.

One of the renewable energy sources that has been the focus of significant research and development has been solar energy. Solar energy can be harvested in a number of ways, such as solar heating, solar photovoltaics (PV), and solar hybrid photovoltaic thermal (PVT) systems.

Due to its capacity to convert sunlight directly into electricity, solar PV has developed significantly over the last couple of decades, making great strides in ease of manufacture, solar conversion efficiency, renewability of construction materials, extended lifespan, low cost, flexibility, and ease of construction and installation.

A current problem with solar energy is that it is dependent on the immediate solar power incident on the panels. Therefore, when obstructed by clouds, or at night, the electrical power output of the solar farm is substantially diminished.

In order to overcome this issue, solar farms include large battery installations to store electrical potential while being charged when the incident solar power is at its greatest, and discharge electricity at times when demand is higher than the power generated by the solar panels alone. An issue with this means of energy storage is that rare earth metals are required to produce the large quantity of batteries needed to provide sufficient storage. This is not necessarily very environmentally friendly, with environmental issues surrounding the mining and manufacture of these batteries.

Other energy storage solutions have been proposed. For example, pumped hydroelectric power has also been considered. Pumped hydroelectric power utilizes excess electricity generated by the solar panels to pump water to an increased elevation, often to an elevated reservoir. Then, when electricity demand increases, the water can be released from the reservoir to power a hydroelectric turbine to generate electricity on-demand. An issue with this means of energy storage is that the solar farm needs to be near a location where pumped hydroelectric power is suitable. This means that not only does the solar farm need to be at a location that is relatively flat to install the solar farm, but it also needs to be near a location that has a large elevation change that is suitable for constructing an elevated reservoir and hydroelectric generators.

Alternatively, mechanical storage has also been considered. Mechanical storage typically includes kinetic energy storage means such as flywheels. An issue with flywheels is that they require strong infrastructure to keep the large mass spinning at a high speed safely. Additionally, flywheels are not energy dense, meaning that per mass of flywheel, relatively small amount of energy can be stored, making the system rather inefficient.

Therefore, there is a need for an improved system for renewable energy production and storage that overcomes at least one or more of the above-mentioned problems. More specifically, but not exclusively, the present disclosure seeks to provide an improved system for renewable energy production and storage.

### SUMMARY

There is provided, according to a first aspect, a system for renewable hydrogen generation and storage. The system comprises at least one solar photovoltaic (PV) panel; an atmospheric water generator electrically powered by electricity generated by the at least one solar PV panel, the atmospheric water generator configured to extract water from a humid atmosphere; a water electrolyzer electrically powered by electricity generated by the at least one solar PV panel, the water electrolyzer configured receive the water extracted by the atmospheric water generator, and configured to produce hydrogen and oxygen from the water using electrolysis; and a metal hydride storage tank for storing the hydrogen produced by the water electrolyzer. Waste heat generated by the atmospheric water generator is used for thermal management of the metal hydride storage tank.

Advantageously, the use of at least one solar PV panel enables the generation of electricity in a renewable manner, utilizing solar radiation.

Additionally, by using an atmospheric water generator, water can be extracted from a humid atmosphere rather than necessitating an alternative water source. By extracting the water from a humid atmosphere, the purity of the water is likely to be higher than alternative sources such as rivers or the sea, where extensive filtration and purification would likely be needed.

By storing the energy generated by the solar PV panels in hydrogen, the present disclosure avoids the need to use large and environmentally harmful batteries. By using electricity in a water electrolyzer, hydrogen and oxygen are produced, that can then be used to generate power when needed. The conversion of electrical energy to chemical potential energy through electrolysis of water into hydrogen is also a highly energy efficient process.

The use of metal hydrides in a storage tank has been found by the inventors to increase the storage capacity of hydrogen, in a safe manner, in contrast to storing hydrogen in a pressurized gaseous or liquid form for example.

By using the waste heat generated by the atmospheric water generator for thermal management of the metal hydride storage tank, the inventors have found that the capacity of hydrogen storage can be increased.

The humid atmosphere may have a relative humidity of greater than 30%. The humid atmosphere may have a relative humidity of greater than 40%. The humid atmosphere may have a relative humidity of between 40% and 80%. The humid atmosphere may have a relative humidity of between 42% and 76%.

It has been found that the system of the present disclosure is capable of operating within a wide range of weather conditions (temperatures and humidities).

The humid atmosphere may have a temperature range of between 15° C. and 50° C. The humid atmosphere may have a temperature range of between 15° C. and 45° C. The humid atmosphere may have a temperature range of between 15° C. and 40° C. The humid atmosphere may have a temperature range of between 19° C. and 37° C.

It has been found that the system of the present disclosure is capable of operating withing a wide range of temperature conditions.

The system may produce potable water at a rate of greater than 8.64 L per day. The system may produce potable water at a rate of greater than 8.64 L per day per atmospheric water generator.

The system of the present disclosure has been found to not only produce and store energy in an efficient and environmentally friendly manner, but also produce clean and pure drinkable water as a byproduct of the process.

The atmospheric water generator may comprise a refrigerant.

The atmospheric water generator may extract water from the humid atmosphere by cooling the humid atmosphere to its dew point.

The metal hydride storage tank may comprise an ABs-type metal hydride. The ABs-type metal hydride may comprise MmNi_{4.6}Fe_{0.4}.

It has been found by the inventors that MmNi_{4.6}Fe_{0.4} is particularly effective at storing hydrogen.

The metal hydride storage tank may be heated by the waste heat when the metal hydride storage tank is in a discharging configuration, whereby hydrogen is being discharged from the metal hydride storage tank.

It has been found that heating the metal hydride storage tank increases the discharge effectiveness of hydrogen from the tank. By using waste heat generated by the atmospheric water generator, the system increases its energy efficiency and therefore more of the solar energy can be used in other part of the process such as the water electrolyzer.

The metal hydride storage tank may be cooled when the metal hydride storage tank is in a charging configuration, whereby hydrogen is being added to the metal hydride storage tank.

Cooling the metal hydride storage tank during the charging process (absorption time) has been found to increase the absorption and hydrogen storage capacity (hydrogen fraction stored).

The system may comprise a water tank fluidly connected to the atmospheric water generator and the water electrolyzer, such that a consistent flow of water into the water electrolyzer can be achieved.

The system may comprise a water filter fluidly connected to the atmospheric water generator and the water tank. The water filter may comprise an active carbon filter. The water filter may comprise an anti-microbial air filter. The water filter may comprise ozone sterilization.

Having a filter may ensure that the water that is being generated by the atmospheric water generator is potable and suitable for human consumption.

The system may comprise a mineral cartridge fluidly connected to the water filter and the water tank, such that the water becomes mineralized prior to entering the water electrolyzer. The at least one solar PV panel may be a bifacial solar PV panel.

The use of bifacial solar PV panels may increase the efficiency of the solar array by enabling the solar panels to convert solar radiation incident on the panels from multiple directions.

The at least one bifacial solar PV panel may be raised above a surface. The surface may comprise a reflective coating, such that albedo of the surface is increased.

The reflective coating of the surface may reflect solar radiation onto a rear (second) face of the solar PV panel. A first face of the solar PV panel may receive direct incident solar radiation. The surface may be a roof.

The reflective coating may comprise paint. The reflective coating may comprise white paint. The reflective coating may be a reflective white paint coating.

Such an arrangement according to embodiments of the present disclosure may enhance the efficiency of the solar PV panels.

There is provided, according to a second aspect of the present disclosure, a method of producing and storing hydrogen. The method comprises receiving sunlight on at least one solar photovoltaic (PV) panel; converting the sunlight into electricity using the at least one solar PV panel; extracting water from a humid atmosphere using an atmospheric water generator, wherein the atmospheric water generator is powered by the electricity; feeding the water into a water electrolyzer; producing hydrogen and oxygen from the water using electrolysis; storing the hydrogen in a metal hydride storage tank; and managing the temperature of the metal hydride storage tank using waste heat generated by the atmospheric water generator.

Managing the temperature may comprise cooling the metal hydride storage tank when storing the hydrogen in the metal hydride storage tank.

Managing the temperature may comprise heating the metal hydride storage tank using the waste heat when discharging the hydrogen stored in the metal hydride storage tank.

The solar PV panel may be a bifacial solar PV panel.

Receiving sunlight may comprise receiving direct sunlight on a first surface of the at least one bifacial solar PV panel; and receiving indirect sunlight on a second surface of the at least one bifacial solar PV panel. The first surface may be opposite the second surface.

It will be apparent to the person skilled in the art that features disclosed in relation to one aspect of the present disclosure may be applicable to or combinable with another aspect of the present disclosure, and vice versa.

### BRIEF DESCRIPTION OF THE DRAWINGS

The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a system for hydrogen generation and storage according to an embodiment of the present disclosure.

FIG. 2 shows a solar array according to an embodiment of the present disclosure.

FIG. 3 shows an artificial neural networks (ANN) model according to an embodiment of the present disclosure.

FIGS. 4a to 4c show the effect of tilt angle, height, and albedo on energy production according to an embodiment of the present disclosure.

FIGS. 5a and 5b show energy production and bifacial gain on a monthly and hourly basis according to an embodiment of the present disclosure.

FIGS. 6a and 6b show the air conditions for the atmospheric water generator on a monthly basis, according to an embodiment of the present disclosure.

FIGS. 6c and 6d show the rate of water production and electrical energy consumption of the atmospheric water generator on a monthly basis, according to an embodiment of the present disclosure.

FIG. 7 shows the spectral radiance of various materials according to an embodiment of the present disclosure.

FIG. 8a shows power and solar irradiance of a bifacial solar photovoltaic (PV) with a reflective coating compared to a monofacial solar PV, according to an embodiment of the present disclosure.

FIG. 8b shows hydrogen production rate and solar to hydrogen (STH) efficiency of a bifacial solar photovoltaic with a reflective coating compared to a monofacial solar PV, according to an embodiment of the present disclosure.

The foregoing and other objects, features, and advantages of the present invention, as well as the invention itself, will be more fully understood from the following description of preferred embodiments, when read together with the accompanying drawings.

### DETAILED DESCRIPTION

The present disclosure relates to the field of renewable energy production and storage, and more particularly to renewable hydrogen production and storage using a metal hydride storage tank.

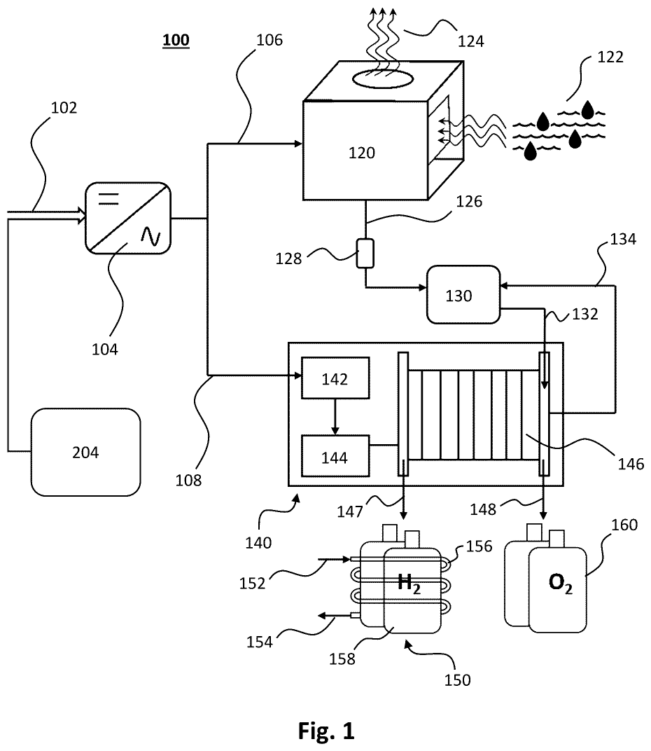

The principles of the present invention and their advantages are best understood by referring to FIG. 1 to FIG. 8b. In the following detailed description of illustrative or exemplary embodiments of the disclosure, specific embodiments in which the disclosure may be practiced are described in sufficient detail to enable those skilled in the art to practice the disclosed embodiments. The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure.

FIG. 1 shows a system for hydrogen generation and storage according to an embodiment of the present disclosure.

As a first step, electricity is generated using at least one solar photovoltaic (PV) panel 204. This generates DC PV electric power 102 that is fed into an inverter 104. The inverter 104 converts DC (direct current) into AC (alternating current).

Power from the inverter 104 is then fed 106 into the atmospheric water generator (AWG) 120.

The AWG 120 functions are based on a thermal cycle (refrigeration-cooling based system). This is used to capture moisture from the humid atmosphere 122 and transform it into water 126 that will eventually be fed into the electrolyzer 140.

The AWG 120 is designed to produce fresh drinking-grade water from ambient humid air. It works on the principle of atmospheric water generation technology. The water is produced by converting the moisture present in the air 122. The device uses R410A refrigerant for the condensation of water vapor in the air by bringing the air temperature to dew point (condensation temperature). The device has 760 W rated power, having an internal storage tank of 26 Liters.

At the output 126 of the AWG, there is provided a filter 128. The filter 128, in embodiments, comprises a plurality of filters. In embodiments, filter 128 comprises ozone sterilization, granulated active carbon filter, and a mineralization cartridge to ensure fresh drinking-grade water at the outlet.

As a byproduct of the operation of the AWG, and more specifically, as a byproduct of the refrigeration cycle, hot dry air 124 is generated and expelled from the AWG.

An antimicrobial air filter present within the AWG removes the airborne particles. The clean humid air flows from the condensation unit and water is collected into a storage tank 130 where ozonation is carried out. An integrated ozone purification system is responsible for disinfection, oxidation, and deodorization. It eliminates contaminations i.e., bacteria, viruses, and impurities. The activated carbon filter further purifies the water by removing physical impurities and finally, mineralization happens in the mineral cartridge before dispensing the water. The high purity water is used then as input in electrolyzer 140 for hydrogen production.

By utilizing humid air from the environment, the system according to an embodiment of the present disclosure is capable of being fully integrated and self-sustainable. The system according to an embodiment of the present disclosure is capable of being situated anywhere where there is sufficient humidity to extract moisture from the ambient air.

With respect to water production of the AWG, water production of 29.8 L per day has been recorded with average ambient conditions of 21.1° C. and 76% relative humidity.

In similar ambient conditions, an average water harvesting rate of 0.95 L/hr. was observed with an energy consumption of 0.84 kWh/L. The average air humidity and temperature in such ambient conditions were 63.25% and 22.16° C.

With respect to the lowest monthly water production rate, in such conditions an average water yield was 0.13 L/hour, with an energy consumption of 1.98 kWh/L. The average atmospheric conditions were 47.46% RH and 18.74° C.

The energy consumption by the device to produce one liter of water varies from 0.84 kWh/L in optimal atmospheric conditions to 3.47 kWh/L in the least optimal atmospheric conditions. Maximum and minimum daily energy consumption of 20.0 and 1.99 kWh were observed.

The annual average water harvesting rate is 0.36 L/hr. with electricity consumption of 2.25 kWh/L.

According to an embodiment of the present disclosure, the energy consumption of the system is less than 2 kWh per liter of water produced. According to an embodiment of the present disclosure, the energy consumption of the system is between 2 and 0.8 kWh per liter of water produced.

Purified water from the storage tank 130 is then fed 132 into the electrolyzer 140. The electrolyzer is powered by AC 108 from inverter 104.

The electrolyzer 140 takes in water 132 from the water storage tank 130. The input power 108 is fed into a power supply 142. The power supply powers the control system 144 that controls the operation of the electrolysis component 146.

Electrolysis component 146 uses electrolysis to separate water into its component parts: hydrogen and oxygen. Hydrogen output 147 is fed to hydrogen storage 150 comprising the hydrogen storage tank 158, during a charging configuration. In embodiments, electrolyzer 146 generates 1 kg of hydrogen per 9 liters of water.

The hydrogen storage tank comprises a metal hydride. The metal hydride is an AB₅-type metal hydride alloy. The metal hydride comprises MmNi_{4.6}Fe_{0.4}.

The MmNi_{4.6}Fe_{0.4} works to store hydrogen by means of a reversible chemical reaction between the metal hydride and gaseous hydrogen.

It has been found that by cooling the storage tank 158 and by cooling the metal hydride, the storage capacity of the tank and metal hydride can be increased when in the charging configuration.

The hydrogen storage 150 comprises a helical heat exchanger 156 that controls the temperature of the hydrogen storage tank 158. The heat transfer fluid within the helical heat exchanger 156 may be water, mono, or a hybrid nanofluid as heat transfer fluid.

In embodiments, phase change material is integrated for the purpose of cooling the hydrogen storage tank.

In embodiments, the hydrogen storage tank is an annular cylinder. Having such a construction may facilitate more optimal heat transfer between the heat exchanger and the contents of the hydrogen storage tank.

Hot dry air 124 that is produced by the AWG may be recovered and recycled to control the temperature of the hydrogen storage 150 and the hydrogen storage tank 158. Using heat to control the temperature of the hydrogen storage 158 during the discharge process of hydrogen from the tank may enhance the rate or amount of hydrogen discharged from the tank.

During heating, the hot dry air 124 may heat the inbound heat transfer fluid 152. The heat transfer fluid then transfers heat to the contents of the hydrogen storage tank 158, thereby leaving the heat exchanger as a cooled heat transfer fluid 154. In embodiments, the temperature of the hot dry air is between 41 degrees Celsius and 51 degrees Celsius.

During cooling, inbound heat transfer fluid 152 may be cooled by a refrigerant or otherwise. The heat transfer fluid then absorbs heat from the contents of the hydrogen storage tank 158, thereby leaving the heat exchanger as a warmed heat transfer fluid 154.

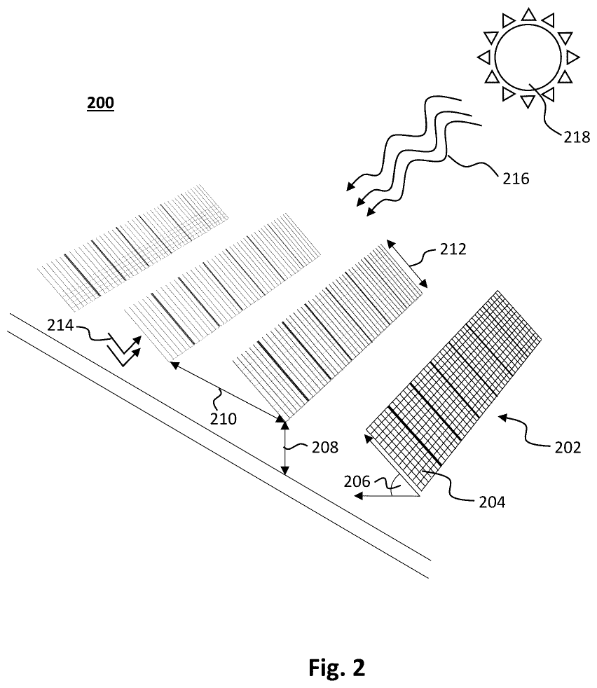

FIG. 2 shows a solar array according to an embodiment of the present disclosure.

Each solar array 202 is comprised of a plurality of solar PV panels 204. Electricity generated by panels 204 and the arrays 202 is fed as power input to the inverter as shown in FIG. 1.

The solar array 202 receives direct incident solar radiation 216 from the Sun 218.

Each solar PV panel 204 is a bifacial solar PV panel, and as such can also receive and convert radiation incident on a second side to electricity. Direct solar radiation 216 lands on the first face of the solar PV panel 204. Solar radiation that is reflected 214 by the surface above which the solar PV panels 204 are located lands on a second face of the solar PV panel. The proportion of solar radiation 216 that is reflected 214 by the surface is called the albedo.

Various characteristics of the solar PV panels 204 and the arrays 202 can be optimized to provide optimal electrical output and conversion of the solar radiation.

Such characteristics include tilt angle 206, height above the surface 208, pitch (separation distance between panels or arrays) 210, and albedo 214.

The albedo can be optimized by selecting a material or coating for the surface above which the solar PV panels 204 are located, which has optimal reflective characteristics.

In embodiments of the present disclosure, the surface is coated in a reflective paint. The reflective paint coating increases the albedo to 79.9% of visible light of the solar spectrum.

In embodiments, the reflective coating has an albedo of greater than 70%. In embodiments, the reflective coating has an albedo of greater than 75%. In embodiments, the reflective coating has an albedo of greater than 79%.

The reflective coating is a highly reflective white paint coating that has a high solar reflectivity.

By including the reflective coating in combination with the bifacial PV panels 204, a 32% increase in electrical energy production by the bifacial PV (bPV) can be achieved.

Moreover, a 26.69% enhancement in solar to hydrogen ratio (STH) efficiency of the system can be achieved with the reflective coating due to improvement in the albedo and power availability of the bifacial solar PV (bPV) panels.

The albedo is one of the most significant parameters between tilt angle and height for bPV production. The increase in albedo factor and height of bPV modules increase the energy yield. The optimum tilt angle of bPV is found to be 35° for higher albedo and elevation of bPV from the surface, as compared to 25° for monofacial PV (mPV). An average daily bifacial gain of 35.68% can be achieved on a clear sunny day with 90% albedo, tilt angle of 35° and at height of 1.5 m above the surface. Maximum specific productions of 192.4 kWh/kWp and 160.6 kWh/kWp have been observed in May for bPV and mPV, respectively while the maximum bifacial gain of 21.93% is found in July.

The term kWp is a term known in the industry as “kilowatt peak.” Kilowatt peak describes the maximum power output that a solar PV panel can generate under industry-wide standard test conditions. In embodiments, the industry-wide standard test conditions are an irradiance of 1 kW/m².

The measurement kWh/kWp calculates the total energy that is produced over an entire year for a panel that has a kWp of 1 (1 kW output under the industry standard test conditions).

Because the measurement kWh/k Wp is not impacted by the internal efficiency of the panel, it is a useful measure to understand the impact of location, weather, orientation (pitch, height, etc.), and tracking.

New quadratic equations or correlations with high accuracy for the annual energy production (E_{Annual}) and bifacial gain (BG) versus the three input factors (albedo, tilt angle and elevation) are determined using response surface methodology.

$$BG ( \% ) = 9.73 + 2.03 A + 0.8988 B + 6.87 C + 0.2087 AB + 0.9544 AC + 0.6452 BC - 0.1222 {A}^{2} - 0.4785 {B}^{2} - 0.3687 {C}^{2}$$

$${E}_{A n n u a l} ( MWh ) = 19.97 + 0.1910 A + 0.1623 B + 1.32 C + 0.0364 A B + 0.2254 A C + 0.1170 B C - 0.2882 {A}^{2} - 0.0866 {B}^{2} - 0.0611 {C}^{2}$$

In the above equations, A represents tilt angle (°) 206, B represents height (m) 208, and C represents Albedo (%) 214.

In embodiments, the model or equation is determined based on parametric study.

The results obtained show that the combination of bifacial solar PV (production of renewable electricity from the front and back sides of the panels installed in the roof of buildings) and cool roof technologies (roof surface coated with white color or heat reflective paint for high albedo and high solar reflectance index SRI) will help to maximize the renewable energy production (supply of energy) and reduce the building energy consumption (reduce the energy demand-cooling load).

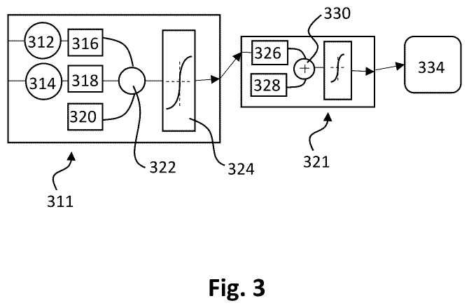

FIG. 3 shows an artificial neural networks (ANN) model according to an embodiment of the present disclosure.

First shown is the input layer 311. The input layer comprises a regression model that comprises input data 312, 314, weights 316, 318, a bias 320, and an output 324. The input variables are tilt angle, height (elevation), and albedo. The output data are bifacial gain and annual energy production.

Each input 312, 314, is multiplied by its respective weight 316, 318, and then summed 322 to obtain a weighted sum. The weighted sum also includes summing of the bias 320.

The output 324 comprises an activation function. The activation function determines whether the output is then passed to output layer 321.

Within the output layer 321, experimental data 328 is compared 330 to the ANN model 326 in order to test the accuracy of the ANN model.

The output layer then passes to output 334 where testing and decision making occurs. Decisions that might be made include power and hydrogen generation forecasts, balance supply and demand, demand side management, and advance energy purchases.

Optimization and ANN models for the present invention are related: power output from the bifacial solar PV with a reflective coating (high albedo); water production from humid air powered from bifacial solar PV—forecasting water production; green hydrogen production—forecasting ahead hydrogen production from the electrolyzer, solar to hydrogen ratio (SHR)—forecasting SHR; and hydrogen storage capacity using thermal management-forecasting the state of hydrogen storage in the tank.

The whole integrated system is optimized, and ANN based models are developed based on the weather conditions (sun—solar irradiance and air—ambient temperature and humidity) and the current state of each component (operating conditions).

The designed ANN models are exceptionally accurate in estimating the bifacial solar PV power and normalized energy output.

For the coated and high roof surface albedo (α=0.8), the values of the coefficient of correlation R (strength of the association of the predictive and simulation data) for training, testing, and validation are 0.99373, 0.99188, and 0.99157, respectively.

The forecast models developed aid in predicting power production from bifacial solar PV with improved roof surface albedo, building operations and maintenance, demand-side management of H2.

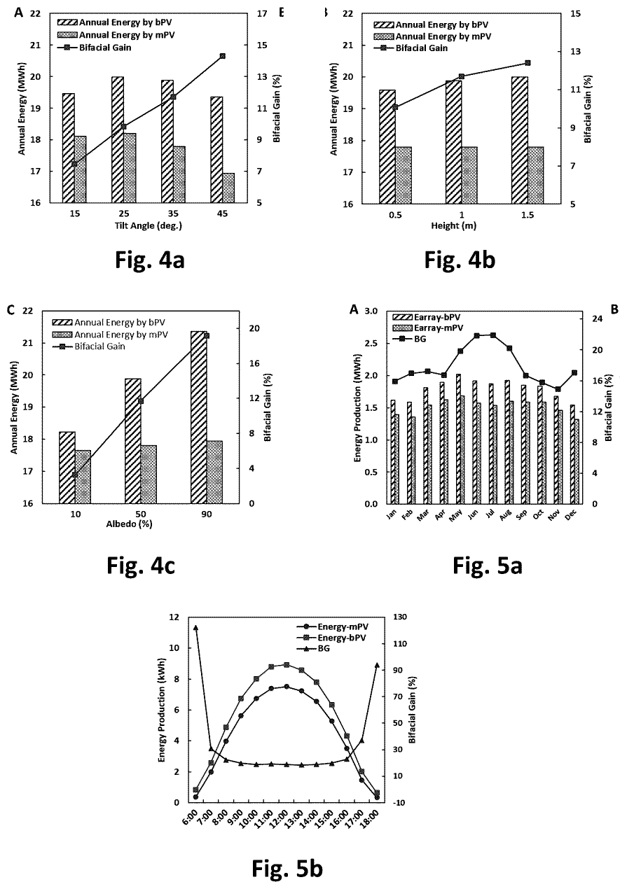

FIGS. 4a to 4c show the effect of tilt angle, height, and albedo on energy production according to an embodiment of the present disclosure.

FIG. 4a shows the effect of tilt angle on energy production according to an embodiment of the present disclosure. Although BG increases with increased tilt angle, the annual energy production is at a peak is in a range between 25° and 35°.

FIG. 4b shows the effect of height on energy production according to an embodiment of the present disclosure. The effect of height has less impact on the amount of energy produced.

FIG. 4c shows the effect of albedo % on energy production according to an embodiment of the present disclosure. It can be clearly seen that a higher albedo has a significant impact on energy production. Since bPV panels also utilize reflected radiation incident on their second, lower, face, the impact of a higher albedo is more pronounced in the bPV panels. At least for this reason, it can be seen that an albedo of 90% results in a BG of approximately 20%.

FIGS. 5a and 5b show energy production and bifacial gain on a monthly and hourly basis according to an embodiment of the present disclosure. As would conventionally be expected, greater energy production was achieved during the summer months (May through to August), and during daylight hours. The inventors have also found that the BG was also increased during the summer months by a significant amount.

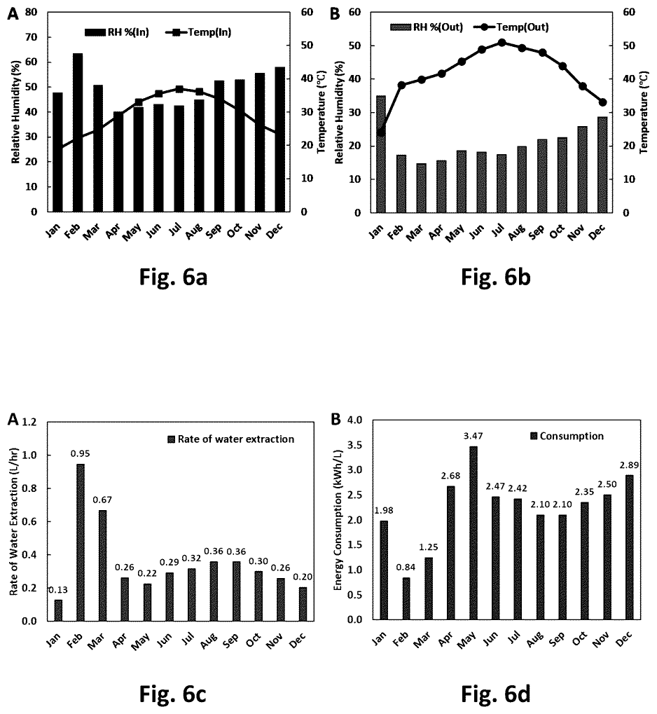

FIGS. 6a and 6b show the air conditions for the atmospheric water generator on a monthly basis, according to an embodiment of the present disclosure. FIGS. 6c and 6d show the rate of water production and electrical energy consumption by the AWG on a monthly basis, according to an embodiment of the present disclosure. The air conditions can be compared to the rate of water production and energy consumption to draw conclusions on factors affecting the rate of water extraction and the rate of energy consumption.

The relative humidity and the inlet air temperature have a significant impact on water harvesting rates.

Maximum water production of 29.8 L was recorded on 11 February with an average temperature of 21.1° C. and 76% relative humidity.

Maximum average water harvesting rate of 0.95 L/hr. was observed in February with an energy consumption of 0.84 kWh/L. The average air humidity and temperature were 63.25% and 22.16° C.

The lowest monthly water production rate was experienced in January. The avg. water yield was 0.13 L/hr. with an energy consumption of 1.98 kWh/L. The average air conditions were 47.46% RH and 18.74° C. This difference in humidity and temperature between the months shows that although the solar radiation intensity would not vary significantly (between January and February), the water production rate can vary substantially as a function of the humidity and atmospheric temperature.

The energy consumption by the device to produce one liter of water varies from 0.84 kWh/L in February to 3.47 kWh/L in May. Maximum and minimum daily energy consumption of 20.0 and 1.99 kWh were observed.

The annual average water harvesting rate is 0.36 L/hr. with electricity consumption of 2.25 kWh/L.

The results have shown that in embodiments, the optimum condition for the machine's operation is 22° C. with a relative humidity of 63%.

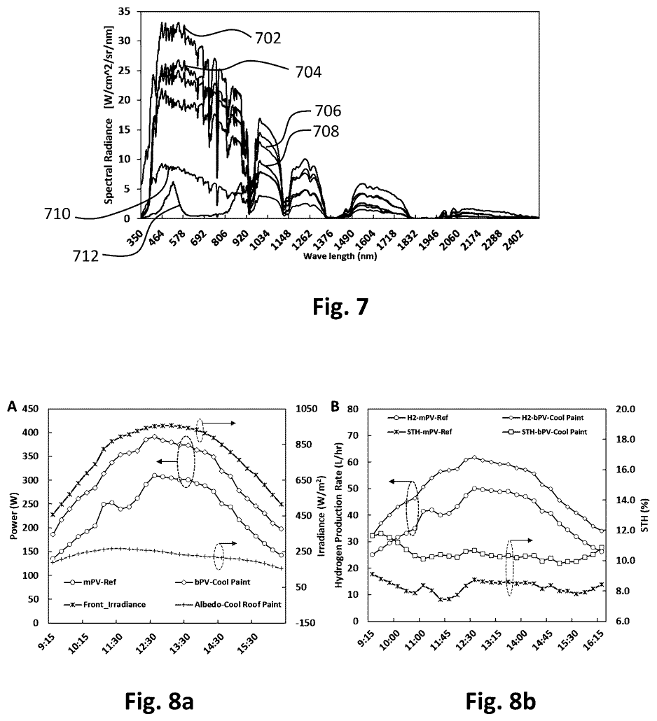

FIG. 7 shows the spectral radiance of various materials according to an embodiment of the present disclosure.

The hydrogen generation system (proton exchange membrane (PEM) electrolyzer) requires water and electricity for its operation. The water is obtained through an atmospheric water generator (AWG) while electricity is generated by the bPV modules having cool roof paint for the enhancement of albedo. Both inputs are fed to the PEM electrolyzer to produce hydrogen in a green and sustainable way.

The generated hydrogen is stored in a metal hydride-based storage tank where thermal management controls the temperature of the tank during charging and discharging.

The maximum production rate of H₂ is 2.65 Liters per minute with power requirements of 1.3 kW. The maximum obtained pressure is 15 bar.

In embodiments, the system of the present disclosure can obtain a production rate of hydrogen of greater than 2 liters/min per kW, or, greater than 120 liters per minute per kWh.

The cool roof paint reflects the 79.90% visible light of the solar spectrum. The rear side irradiance of 227.22 W/m2 was observed on the bPV panel, causing 32.13% more electrical energy production by the bPV panel.

As can be seen in the figure, the cool roof paint (reflective white paint coating) 704 is the highest performing covering relative to the reference 702. Other surfaces shown are wallpaper 706, cardboard 708, grey 710, and green 712.

FIG. 8a shows power and solar irradiance of a bifacial solar photovoltaic (PV) with a reflective coating compared to a monofacial solar PV, according to an embodiment of the present disclosure.

FIG. 8b shows hydrogen production rate and solar to hydrogen (STH) efficiency of a bifacial solar photovoltaic with a reflective coating compared to a monofacial solar PV, according to an embodiment of the present disclosure.

A 27.31% enhancement in green hydrogen production is achieved with cool roof paint as reflecting material due to improvement in the albedo and power availability of the bPV panels.

A 26.69% enhancement in Solar to hydrogen STH efficiency of the system is achieved with cool roof paint as reflecting material due to improvement in the albedo and power availability of the bPV panels.

TABLE 1
mPV hydrogen generation compared to bPV with cool roof paint.

| | | | | | | | Inc. in |
|---|---|---|---|---|---|---|---|
| | | | | Hydrogen Generation | | STH | STH |
| | Irradiance | | | Rate of H₂ | | | |
| Description of | Front | Rear | Power | production | Increase | | |
| Material | W/m² | W/m² | W | L/hr. | % | % | % |
| m-Ref | 785.04 | −227.22 | 232.37 | 39.04 | 27.31 | 8.27 | |
| bPV-Cool Roof | | | 307.03 | 49.70 | | 10.48 | 26.69 |
| Paint | | | | | | | |

It can be seen that there is an increase in solar to hydrogen ratio of 26.69% when switching from typical mPV to a bPV with cool roof paint, according to an embodiment of the present disclosure.

By implementing embodiments of the present disclosure, the inventors have realized a number of advantages over prior systems. Those advantages include but are not limited to:
a) A self-sustained green H₂ production system that depends only on weather conditions (sun and air).
b) Boosting the renewable electricity generation using innovative solar PV technology.
c) Boosting green hydrogen production.
d) Boosting the solar to hydrogen ratio.
e) Increasing the storage capacity of the metal hydride storage tank.
f) Using AI/machine learning models to accurately predict or forecast the hydrogen production, including short-term forecasting.
g) Electricity requirements that are fulfilled by renewable energy sources i.e., bifacial solar PV panels with integrated cool roof paint to boost the albedo and hence the bPV production.
h) Achieving 32.13% energy production.
i) Using Atmospheric water technology is integrated to fulfil the water requirements, therefore not requiring a separate source of water.
j) Generating potable water as a product of the system.
k) Achieving 99.999% pure hydrogen generation at 15 bar pressure.
l) Achieving a 26.69% enhancement in STH efficiency of the system with bPV and cool roof paint.
m) Achieving 27.31% enhancement in green hydrogen production with bPV and cool roof paint.
n) Generating low-pressure hydrogen with high purity.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The disclosures and the description herein are intended to be illustrative and are not in any sense limiting the present disclosure, defined in scope by the following claims.

Many changes, modifications, variations and other uses and applications of the present disclosure will become apparent to those skilled in the art after considering this specification and the accompanying drawings, which disclose the preferred embodiments thereof. All such changes, modifications, variations and other uses and applications, which do not depart from the spirit and scope of the present disclosure, are deemed to be covered by the invention, which is to be limited only by the claims which follow.

1. A system for renewable hydrogen generation and storage, the system comprising:
at least one solar photovoltaic (PV) panel;
an atmospheric water generator electrically powered by electricity generated by the at least one solar PV panel, the atmospheric water generator configured to extract water from a humid atmosphere;
a water electrolyzer electrically powered by electricity generated by the at least one solar PV panel, the water electrolyzer configured to receive the water extracted by the atmospheric water generator, and configured to produce hydrogen and oxygen from the water using electrolysis; and
a metal hydride storage tank for storing the hydrogen produced by the water electrolyzer;
wherein, waste heat generated by the atmospheric water generator is used for thermal management of the metal hydride storage tank, wherein the system is configured to heat the metal hydride storage tank using the waste heat when the metal hydride storage tank is in a discharging configuration, whereby hydrogen is being discharged from the metal hydride storage tank.

2. The system as claimed in claim 1, wherein the atmospheric water generator comprises a refrigerant.

3. The system as claimed in claim 1, wherein the atmospheric water generator is configured to extract water from the humid atmosphere by cooling the humid atmosphere to its dew point.

4. The system as claimed in claim 1, wherein the metal hydride storage tank comprises an AB₅-type metal hydride.

5. The system as claimed in claim 4, wherein the ABs-type metal hydride comprises MmNi_{4.6}Fe_{0.4}.

6. (canceled)

7. The system as claimed in claim 1, wherein the system is further configured to cool the metal hydride storage tank when the metal hydride storage tank is in a charging configuration, whereby hydrogen is being added to the metal hydride storage tank.

8. The system as claimed in claim 1, wherein the system comprises a water tank fluidly connected to the atmospheric water generator and the water electrolyzer, such that a consistent flow of water into the water electrolyzer can be achieved.

9. The system as claimed in claim 8, wherein the system comprises a water filter fluidly connected to the atmospheric water generator and the water tank.

10. The system as claimed in claim 9, wherein the water filter comprises an active carbon filter.

11. The system as claimed in claim 9, wherein the water filter comprises an anti-microbial air filter.

12. The system as claimed in claim 9, wherein the water filter comprises ozone sterilization.

13. (canceled)

14. The system as claimed in claim 1, wherein the at least one solar PV panel is a bifacial solar PV panel.

15. The system as claimed in claim 14, wherein the at least one bifacial solar PV panel is raised above a surface,
wherein the surface comprises a reflective coating, such that albedo of the surface is increased.

16. A method of producing and storing hydrogen, the method comprising:
receiving sunlight on at least one solar photovoltaic (PV) panel;
converting the sunlight into electricity using the at least one solar PV panel;
extracting water from a humid atmosphere using an atmospheric water generator;
feeding the water extracted by the atmospheric water generator into a water electrolyzer;
producing hydrogen and oxygen from the water in the water electrolyzer using electrolysis;
storing the hydrogen in a metal hydride storage tank; and
managing the temperature of the metal hydride storage tank using waste heat generated by the atmospheric water generator, wherein the managing the temperature comprises heating the metal hydride storage tank using the waste heat when discharging the hydrogen stored in the metal hydride storage tank,
wherein the atmospheric water generator and the water electrolyzer are powered by the electricity generated by the at least one solar PV panel.

17. The method as claimed in claim 16, wherein the managing the temperature further comprises cooling the metal hydride storage tank when storing the hydrogen in the metal hydride storage tank.

18. (canceled)

19. The method as claimed in claim 16, wherein the solar PV panel is a bifacial solar PV panel.

20. The method as claimed in claim 19, wherein the receiving sunlight comprises:
receiving direct sunlight on a first surface of the at least one bifacial solar PV panel; and
receiving indirect sunlight on a second surface of the at least one bifacial solar PV panel;
wherein the first surface is opposite the second surface.

21. The system as claimed in claim 1, further comprising a heat exchanger configured to transfer the waste heat to the metal hydride storage tank when the metal hydride storage tank is in the discharging configuration.
